(19) United States
(12) Patent Application Publication
(10) Pub. No.: US 2003/0121190 A1
(43) Pub. Date: Jul. 3, 2003

(54) Energy-efficient rotary display stand

(76) Inventor: Ofer Spivak, Modiin (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/029,280

(22) Filed: Dec. 28, 2001

(51) Int. Cl. G09F 19/08

(52) U.S. Cl. 40/411; 40/414

(57) ABSTRACT

A rotating stand having: (a) a rotatable display; (b) a vertical shaft connected to and extending from the display at a first end, and (c) a shaft assembly, mounted on the shaft, the assembly including: (i) a rotary bearing concentric with the shaft and providing support for the housing and the shaft while allowing the shaft to rotate around a vertical axis; (ii) a coupling functionally attached to the shaft, for rotating the shaft and the display; (iii) a mechanism engaging the coupling and providing rotational energy to the coupling, and (iv) a cordless power supply providing electrical power to the mechanism.

### FIELD AND BACKGROUND OF THE INVENTION

The present invention relates to rotating stands that rotate around a vertical axis, making the merchandise, advertising, or information displayed thereon accessible from all directions. More particularly, the present invention relates to cordless, energy-efficient rotating stands. Rotating display stands for retail settings are well known. They offer the advantage of making more merchandise or information accessible than a comparably sized fixed shelf of similar depth. The effective display area of such a rotating display is proportional to its circumference or perimeter, as compared to an equal area of fixed shelf space, which presents only one face to the customer providing between one third and one fourth of the display area of the rotating stand. Typically, rotating display stands are stationary until set in motion by the customer.

Signs and displays that involve motion in a retail setting are also well known, ranging from large motorized rotating signs at the scale of highway visibility, to small pennants, propellers, or reflectors designed to wave in the wind. These devices attract attention through motion in the field of vision of the potential customer, and use this moment of attention to transmit a retail message. Blinking lights use a similar phenomenon of implied motion to attract attention, and have been widely implemented in a variety of retail applications.

In a supermarket or department store setting, there is a clear interest on the part of the retailer to attract attention to certain items within the store. Also in retail settings in which competing businesses share public spaces as in malls or shopping streets, individual businesses have an interest in attracting attention to their goods or services within this space. A single product that combines motion and display of goods or information would serve these retailing interests well and emphasize the presence of a particular range of merchandise within the retail space.

One impediment to the adoption of motorized rotating display stands relates to the electrical power supply requirement. A display stand relying on line voltage requires the running of cables to the stand. This either demands infrastructure preparation (which also limits mobility and choice of location) or leaves external cables running across floors meant for the smooth and nonhazardous movement of people and wheeled carts. Thus, in practice, the safe operation of such powered rotating stands requires that the stands be fixed to specific places in the store where electrical points have been prepared in floors, ceiling, or adjacent furnishings. Moreover, a wired electrical power supply is often unavailable or unreliable.

Battery power is often a reasonable alternative to conventional, wired power supplies. The use of batteries, moreover, provides the great advantage of portability, such that the display device can be mounted at any point in the store or outside, regardless of infrastructure preparations, even in areas that are far removed from electrical line voltage.

The deficiencies of a battery-powered display device are also manifest. Typical display devices are heavy, and consequently have a significant power demand. Thus, standard batteries are appropriate for powering very small and lightweight displays, or possibly for powering larger rotating stands for a very short period of time before the battery loses power. It is decidedly disadvantageous to have to frequently replace batteries in display devices, as this is labor-intensive, cost intensive, and requires the store staff to take notice of the inoperative display device. Moreover, it is aesthetically displeasing to many customers to view a rotating display device in an inoperative state, and from a marketing point of view, it is unfavorable to have such displeasure associated with the product being marketed.

Thus, there is a clear need for a product that combines the display advantages inherent to passively rotating display stands, the attention-getting advantages of moving signs or displays, and the portability and ease of placement afforded by battery powered devices, a product that enables the use of a rotating display that is of sufficient size to be prominent in a retail environment, and that has sufficient duration of power to make its use practical.

### SUMMARY OF THE INVENTION

According to the present invention there is provided a rotating stand having: (a) a rotatable display; (b) a vertical shaft connected to and extending from the display at a first end, and (c) a shaft assembly, mounted on the shaft, the assembly including: (i) a rotary bearing concentric with the shaft and providing support for the housing and the shaft while allowing the shaft to rotate around a vertical axis; (ii) a coupling functionally attached to the shaft, for rotating the shaft and the display; (iii) a mechanism engaging the coupling and providing rotational energy to the coupling, and (iv) a cordless power supply providing electrical power to the mechanism.

According to preferred embodiments described hereinbelow, the stand further provides means for adjusting the distance between the bearings and the display. The coupling may consist of sliding intermeshing gears, a flexible axle, or a system of pulleys and belts. The display stand is powered by an electrical motor which may be battery powered, and may include a light-sensitive switch that shuts off operation ambient light falls below a certain value. An alternative embodiment of the invention is powered partially or completely by a photovoltaic cell.

Under typical store-lighting conditions, the rotating display stand is capable of rotating a display having a weight of 10 kg for over 30 days using three standard “D” cell batteries.

### BRIEF DESCRIPTION OF THE DRAWINGS

The invention is herein described, by way of example only, with reference to the accompanying drawings wherein:

FIG. 1 is a perspective view of one embodiment of a powered rotating display stand according to the invention;

FIG. 2 is a perspective view of the powered rotating display stand with the housing partially cut away to expose the inner workings of the rotating apparatus;

FIG. 3 is an enlarged perspective view of the rotating apparatus with the housing removed;

FIG. 4 is a cross section of the rotating apparatus, and

FIG. 5 is a perspective view of a rotating stand of the prior art.

### DESCRIPTION OF THE PREFERRED EMBODIMENTS

The present invention is of a cordless, low-energy-use rotating display stand that is suitable for displaying merchandise or information in a retail environment. The principles and operation of such a display stand according to the present invention may be better understood with reference to the drawings and the accompanying description.

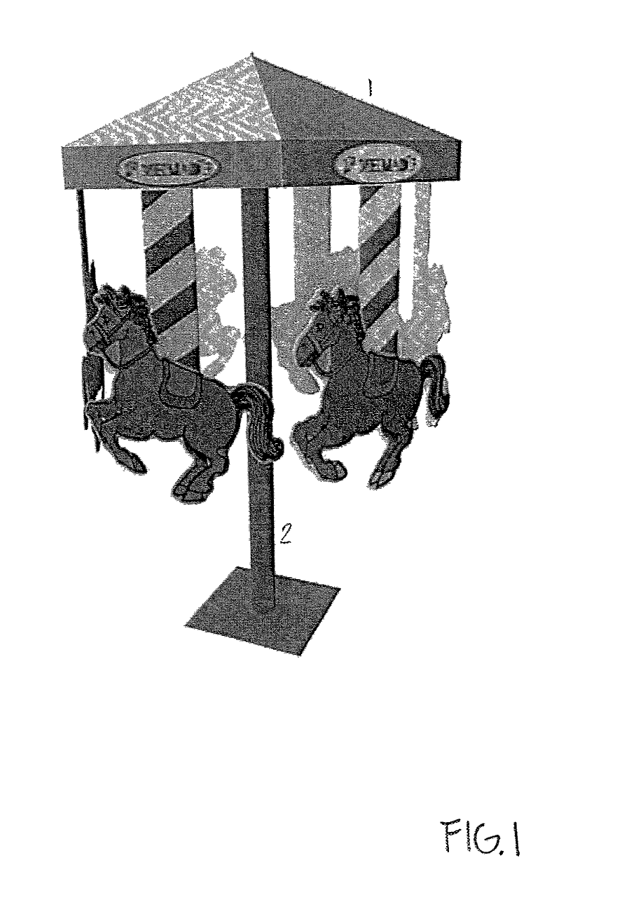

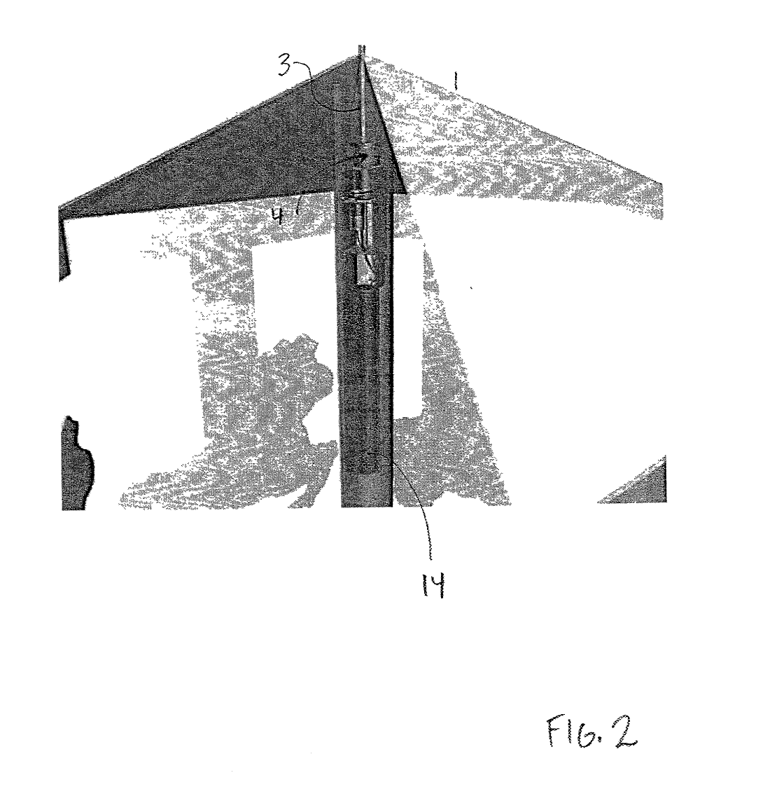

Referring now to the drawings, FIG. 1 shows a rotatable display 1 supported by a column 2 connected to a base 3. Visible on the upper portion of display 1 is a photovoltaic power source 17. FIG. 2 is a perspective view of the powered rotating display stand with the housing partially removed to show the inner workings of the rotating apparatus. Display 1 is supported at its center by a threaded shaft 4 which is connected to the inner rotating section of a rotary bearing 5.

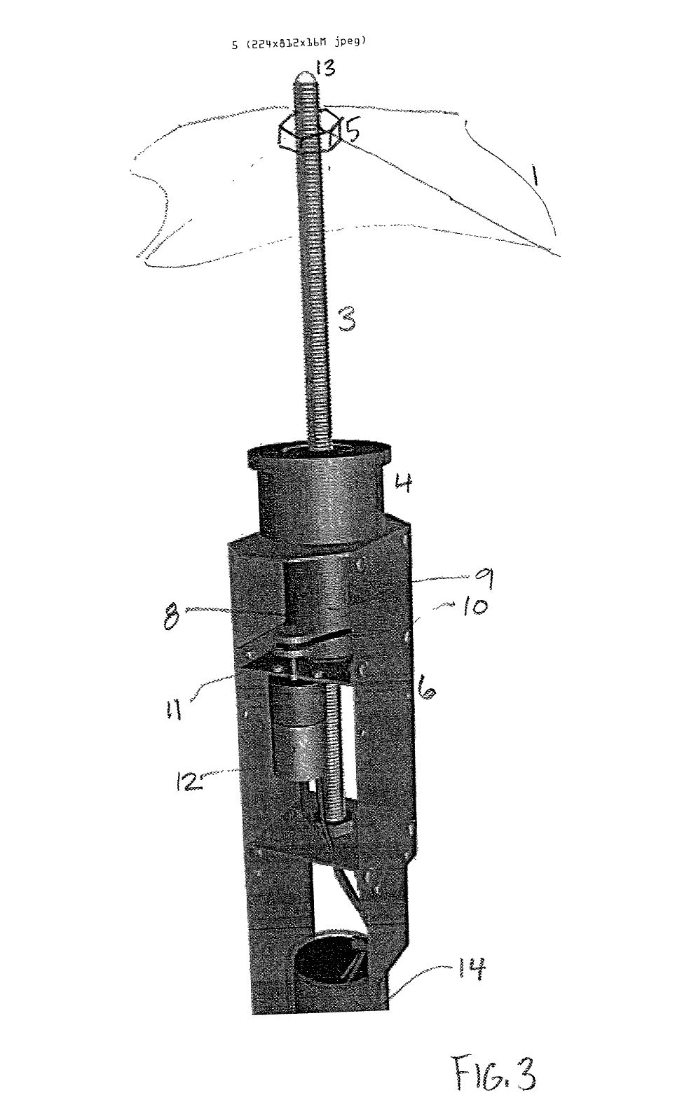

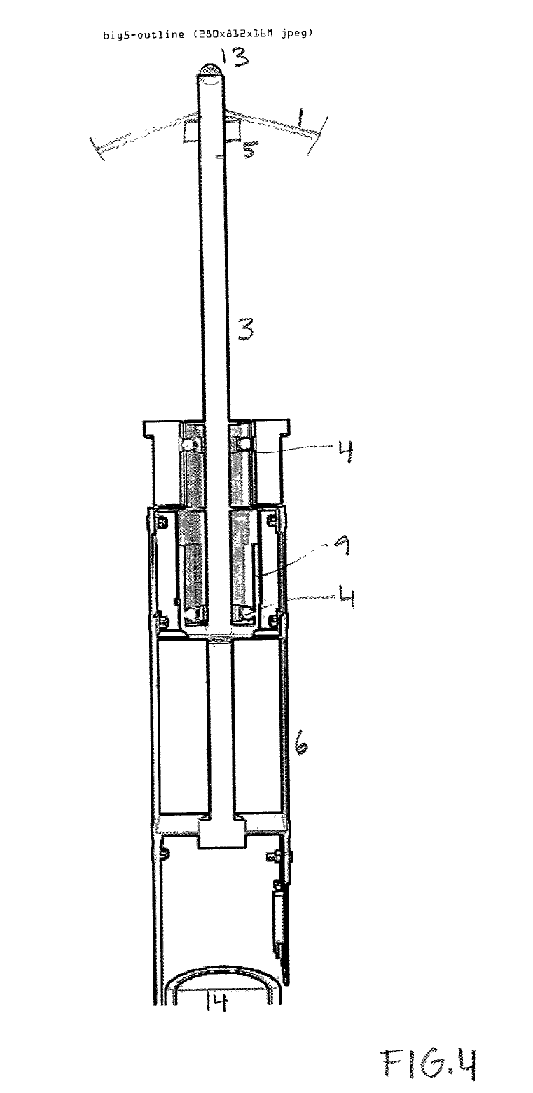

With reference to FIGS. 3 and 4, FIG. 3 is a magnified perspective view of the rotating apparatus with display 1 removed. The shaft 4 is provided with a nut 6 for adjusting the distance between bearing 5 and housing 1. The outer section of bearing 5 is connected to a column 2 which is connected to a base 3 resting on the ground. The shaft 4 is free to rotate relative to column 2 and base 3, but bearing 5 is constructed such that the weight of housing 1 is carried by column 2and base 3. The shaft 4 continues through bearing 5 to a coupling 7 consisting of a drum shaped pulley element 8 that engages with a belt 9 driven by a flanged pulley 10, which is in turn driven by an electrical motor 11. Motor 11 is connected electrically to a circuit including a light sensitive sensor 12 and a self contained power supply 13.

In the current invention. the weight of the display 1 and the shaft 4 are carried to the ground by bearing 5, column 2 and base 3. Bearing 5 in addition is designed and constructed such that it reduces the friction of rotating the display to a minimum.

Preferably, belt 9 is loosely connected, so as to reduce friction-related losses and improve the energy efficiency. A further advantage is that the mechanism is robust with respect to abrupt changes in speed, as a result of improper operation on the part of an operator, or, perhaps more commonly, on the part of a customer who tampers with the stand (e.g., a curious child).

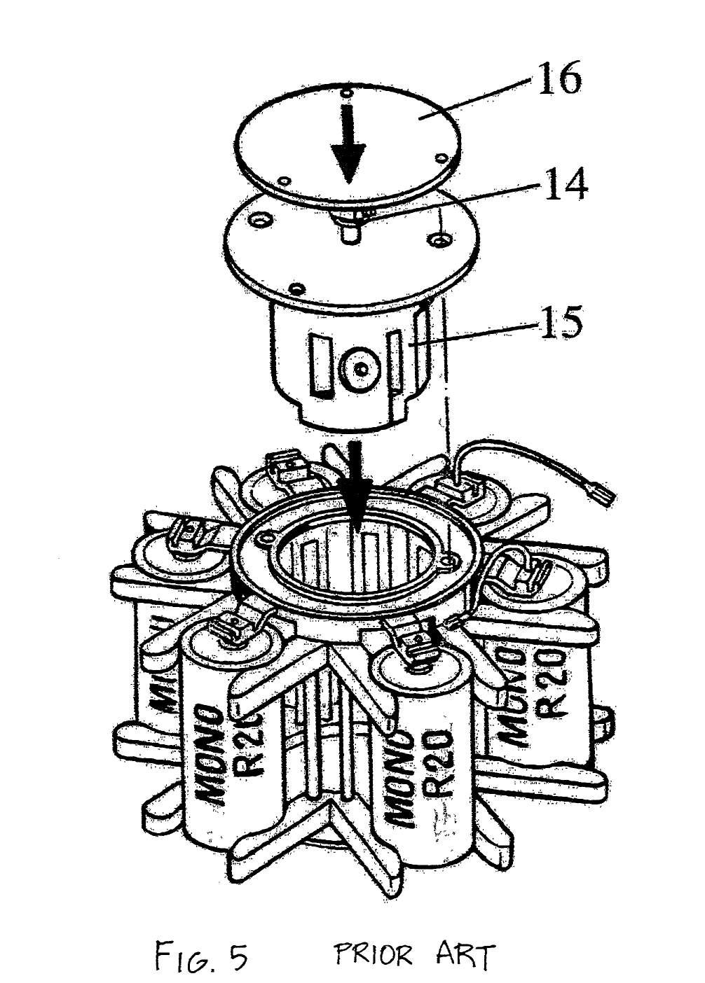

FIG. 5 shows an example of prior art in which the shaft 14 of the motor 15 is connected concentrically to a disk 16 upon which a display can be placed. In this example, the weight of the shaft 14, disk 16, and the display is carried by the rotor section of the motor. As can be expected, this additional load on the rotor increases the power requirements of the motor. Consequently, battery-powered rotating display stands are rare in the prior art, and are generally limited to stands bearing a display weight of less than 1 kg. Examples of contemporary commercial products in which battery powered rotary stands are limited to 1 kg. loads can be seen in the MTE product catalog, Germany, particularly the BM 010 Battery Motor line.

In studies conducted to ascertain the differential in power requirements between the current invention and the prior art as represented by the mechanism shown in FIG. 5, it has been shown that this differential is greater than an order of magnitude. For example, given a 10 kilogram load, a calculated power requirement of 0.2 watts is sufficient to rotate the load according to the present invention, as compared with a calculated power requirement of 2.5 watts according to the standard design of the prior art. This substantial efficiency improvement enables the practical application of a cordless power supply such as a battery to rotating stand applications, even stands in which the display weight is well over 10 kg. With a load of 10 kg, 3 D cell batteries will power the device for 30 to 60 days without replacement.

Other power saving aspects of the current invention are implemented in an additional embodiment in order to further extend battery life. Light sensitive sensor 12 is connected electrically to the circuit that drives the motor such that when light conditions are low, the system is shut off, further saving battery power. In addition, photovoltaic power source 17 is connected electrically to the circuit that drives the motor such that in conditions of high illumination, it provides an auxiliary power supply, augmenting or replacing the battery as a source of power.

As a result of these improvements battery life for a typical retail display embodiment of the current invention is typically at least 2-3 months, as compared with 1 week of operation for prior art under identical loads.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A rotating stand, comprising:
(a) a rotatable display;
(b) a vertical shaft connected to and extending from said display at a first end, and
(c) a shaft assembly, mounted on said shaft, said assembly including:
(i) a rotary bearing concentric with said shaft and providing support for said housing and said shaft while allowing said shaft to rotate around a vertical axis;
(ii) a coupling functionally attached to said shaft, for rotating said shaft and said display;
(iii) a mechanism engaging said coupling and providing rotational energy to said coupling, and
(iv) a cordless power supply providing electrical power to said mechanism.

1. 2. The rotating display stand as in claim 1, further comprising:
(d) means for adjusting a distance between said rotary bearing and said display.

3. The rotating display stand as in claim 1, wherein said coupling is an assembly of gears designed and configured such that said gears remain enmeshed and transfer rotational energy while free to move a specified distance relative to one another along their axis of rotation.

4. The rotating display stand as in claim 1, wherein said coupling is a flexible shaft.

5. The rotating display stand as in claim 1, wherein said coupling includes an assembly of at least one pulley and at least one belt designed and configured, such that said at least one pulley and said at least one belt remain engaged in proper tension, maintaining contact and transfer of rotational energy while free to move a specified distance relative to one another along their axis of rotation.

6. The rotating display stand as in claim 1, wherein said mechanism for providing rotational energy is an electrical motor, and wherein said power supply is a battery.

7. The rotating display stand as in claim 6, further comprising:
(d) a light sensing device operatively connected to said motor, said device configured so as to turn off current to said motor when measured ambient light drops below a predetermined value.

8. The rotating display stand as in claim 1, wherein said mechanism for providing rotational energy is an electrical motor, and wherein said power supply includes a photovoltaic cell.

9. The rotating display stand as in claim 1, wherein said shaft is connected to said shaft assembly such that a second end of said shaft is substantially freely rotating.

10. The rotating display stand as in claim 1, wherein said rotatable display has a weight in excess of 3 kg.

11. The rotating display stand as in claim 1, wherein said rotatable display has a weight in excess of 5 kg.

12. The rotating display stand as in claim 1, wherein said rotatable display has a weight in excess of 10 kg.

13. The rotating display stand as in claim 1, the stand having a power consumption requirement of P watts, said rotatable display having a weight of W kg, and wherein a ratio of P to W is less than 0.2.

14. The rotating display stand as in claim 1, the stand having a power consumption requirement of P watts, said rotatable display having a weight of W kg, and wherein a ratio of P to W is less than 0.1.

15. The rotating display stand as in claim 1, the stand having a power consumption requirement of P watts, said rotatable display having a weight of W kg, and wherein a ratio of P to W is less than 0.05.

16. The rotating display stand as in claim 13, wherein said cordless power supply is a battery.

17. The rotating display stand as in claim 13, wherein said power supply includes a photovoltaic cell.
